(19) United States
(12) Patent Application Publication
(10) Pub. No.: US 2017/0339604 A1
(43) Pub. Date: Nov. 23, 2017

(54) CONFIGURATION METHOD FOR COEXISTENT INTERFERENCE FREQUENCY SET, BASE STATION AND UE

(71) Applicant: FUJITSU LIMITED, Kawasaki-shi (JP)

(72) Inventors: Weiwei WANG, Beijing (CN); Haibo XU, Beijing (CN); Hua ZHOU, Beijing (CN)

(73) Assignee: FUJITSU LIMITED, Kawasaki-shi (JP)

(21) Appl. No.: 15/672,999

(22) Filed: Aug. 9, 2017

Related U.S. Application Data
(62) Division of application No. 14/501,948, filed on Sep. 30, 2014.
Application No. 14/501,948 is a continuation of application No. PCT/CN2012/074889, filed on Apr. 28, 2012.

(51) Int. Cl. H04W 36/00; H04W 16/14; H04W 24/10

(52) U.S. Cl. CPC H04W 36/0055; H04W 16/14; H04W 24/10

(57) ABSTRACT

A base station, includes: a transmitter, configured to transmit a first coexistent interference frequency set configured for UE to a target base station, when the UE is handed over from a source base station to the target base station; wherein coexistence interference on each frequency in the first coexistence interference frequency set is to be evaluated by the UE when the UE is in a cell of the source base station, and the evaluation results indicate that whether there exists coexistent interference on each frequency in the first coexistent interference frequency set.

### CROSS REFERENCE TO RELATED APPLICATIONS

This is a divisional application of U.S. application Ser. No. 14/501,948, filed Sep. 30, 2014 which is a continuation of International Application No. PCT/CN2012/074889, filed on Apr. 28, 2012, expired, the contents of each are herein wholly incorporated by reference.

### TECHNICAL FIELD

The present disclosure relates to the field of communications, and in particular to a configuration method for a coexistent interference frequency set, a base station and UE.

### BACKGROUND

In order to achieve network access everywhere, terminal equipment needs to be equipped with multiple sets of transceivers for accessing various networks. For example, the terminal equipment may be simultaneously equipped with transceivers of a long-term evolution (LTE) system and an industrial scientific medical (ISM) system (such as WiFi, and Bluetooth, etc.), etc. As multiple sets of transceivers in the same terminal equipment are very close to each other, power of a transmitter of a system may be much higher than that of a receiver of another system.

FIG. 1 gives an example of interference coexistence. As shown in FIG. 1, the terminal equipment may include an LTE system, a GPS system and a Bluetooth/WiFi system, wherein the LTE system may bring interference to the Bluetooth/WiFi system, and the Bluetooth/WiFi system may also bring interference to the LTE system.

Currently, in a coexistent interference avoidance mechanism of LTE-A, a base station may configure a coexistent interference frequency set for UE, so that the UE needs only to evaluate whether there exists coexistent interference in frequencies in the coexistent interference frequency set. And then the UE may transmit an evaluation result of these frequencies to the base station, thereby reducing times of evaluation of frequencies by the UE and improving system performance.

However, in the implementation of the present disclosure, the inventors found that following defect exists in the prior art: a target base station will reconfigure a coexistent interference frequency set for UE when the UE is handed over from a source base station to the target base station. Actually, such reconfiguration is redundant if a frequency set of the source base station is identical to that of the target base station. And overhead of configuring a coexistent interference frequency set is relatively large, resulting in waste of system resources, and lowering the system performance.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

Embodiments of the present disclosure provide a configuration method for a coexistent interference frequency set, a base station and UE, with an object being to reduce configuration of coexistent interference frequency sets by a base station.

According to an aspect of the embodiments of the present disclosure, there is provided a configuration method for a coexistent interference frequency set, including:

receiving, by a target base station, a first coexistent interference frequency set configured for UE transmitted by a source base station, when the UE is handed over from the source base station to the target base station; and

comparing, by the target base station, the first coexistent interference frequency set with a preset second coexistent interference frequency set, and not reconfiguring a coexistent interference frequency set for the UE if a result of the comparison is that they are identical.

According to another aspect of the embodiments of the present disclosure, there is provided a configuration method for a coexistent interference frequency set, including:

transmitting, by a source base station to a target base station, a first coexistent interference frequency set configured for UE, when the UE is handed over from the source base station to the target base station.

According to still another aspect of the embodiments of the present disclosure, there is provided a configuration method for a coexistent interference frequency set, including:

performing, by UE, coexistent interference evaluation on frequencies in a first coexistent interference frequency set, when the UE does not receive information on reconfiguring a coexistent interference frequency set;

wherein the first coexistent interference frequency set is configured by a source base station; when the UE is handed over from the source base station to a target base station, the first coexistent interference frequency set is transmitted by the source base station to the target base station; and the target base station does not reconfigure a coexistent interference frequency set for the UE if the first coexistent interference frequency set is identical to a preset second coexistent interference frequency set.

According to still another aspect of the embodiments of the present disclosure, there is provided a base station, including:

a first receiving unit, configured to receive a first coexistent interference frequency set configured for UE transmitted by a source base station, when the UE is handed over from the source base station to a target base station; and

a comparing unit, configured to compare the first coexistent interference frequency set with a preset second coexistent interference frequency set; wherein if a result of the comparison is that they are identical, the target base station does not reconfigure a coexistent interference frequency set for the UE.

According to still another aspect of the embodiments of the present disclosure, there is provided a base station, including:

a third transmitting unit, configured to transmit a first coexistent interference frequency set configured for UE to a target base station, when the UE is handed over from a source base station to the target base station.

According to still another aspect of the embodiments of the present disclosure, there is provided UE, including:

an evaluating unit, configured to perform coexistent interference evaluation on frequencies in a first coexistent interference frequency set when no information on reconfiguring a coexistent interference frequency set is received;

wherein the first coexistent interference frequency set is configured by a source base station; when the UE is handed over from the source base station to a target base station, the first coexistent interference frequency set is transmitted by the source base station to the target base station; and the target base station does not reconfigure a coexistent interference frequency set for the UE if the first coexistent interference frequency set is identical to a preset second coexistent interference frequency set.

According to still another aspect of the embodiments of the present disclosure, there is provided a computer-readable program, wherein when the program is executed in a base station, the program enables a computer to carry out the configuration method for a coexistent interference frequency set as described above in the base station.

According to still another aspect of the embodiments of the present disclosure, there is provided a storage medium in which a computer-readable program is stored, wherein the computer-readable program enables a computer to carry out the configuration method for a coexistent interference frequency set as described above in an base station.

According to still another aspect of the embodiments of the present disclosure, there is provided a computer-readable program, wherein when the program is executed in UE, the program enables a computer to carry out the configuration method for a coexistent interference frequency set as described above in the UE.

According to still another aspect of the embodiments of the present disclosure, there is provided a storage medium in which a computer-readable program is stored, wherein the computer-readable program enables a computer to carry out the configuration method for a coexistent interference frequency set as described above in UE.

The advantage of the embodiments of the present disclosure exists in that: not reconfiguring a coexistent interference frequency set for the UE by the target base station if the first coexistent interference frequency set and the second coexistent interference frequency set are identical, when the target base station receives the first coexistent interference frequency set configured for the UE and transmitted by the source base station when the UE is handed over from the source base station to the target base station, configuration of coexistent interference frequency by the base station may be reduced, waste of system resources is lowered, and performance of the system is improved.

With reference to the following description and drawings, the particular embodiments of the present disclosure are disclosed in detail, and the principle of the present disclosure and the manners of use are indicated. It should be understood that the scope of the embodiments of the present disclosure is not limited thereto. The embodiments of the present disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/includes” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be enlarged or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is an example of interference coexistence in the prior art;

FIG. 2 is a flowchart of the configuration method of Embodiment 1 of the present disclosure;

FIG. 3 is another flowchart of the configuration method of Embodiment 1 of the present disclosure;

FIG. 4 is a flowchart of the configuration method of Embodiment 2 of the present disclosure;

FIG. 5 is another flowchart of the configuration method of Embodiment 2 of the present disclosure;

FIG. 6 is a flowchart of the configuration method of Embodiment 3 of the present disclosure;

FIG. 7 is another flowchart of the configuration method of Embodiment 3 of the present disclosure;

FIG. 8 is a schematic diagram of the structure of the base station of Embodiment 4 of the present disclosure;

FIG. 9 is another schematic diagram of the structure of the base station of Embodiment 4 of the present disclosure;

FIG. 10 is a schematic diagram of the structure of the UE of Embodiment 5 of the present disclosure;

FIG. 11 is another schematic diagram of the structure of the UE of Embodiment 5 of the present disclosure; and

FIG. 12 is a schematic diagram of the structure of the base station of Embodiment 6 of the present disclosure.

### DETAILED DESCRIPTION

The foregoing and other features of the embodiments of the present disclosure will become apparent with reference to the drawings and the following description. In the description and drawings, particular embodiments of the present disclosure are disclosed, which show some embodiments in which the principle of the present disclosure may be employed. It should be understood that the present disclosure is not limited to the described embodiments, on the contrary, the present disclosure includes all the modifications, variants and the equivalents thereof falling within the scope of the appending claims.

### Embodiment 1

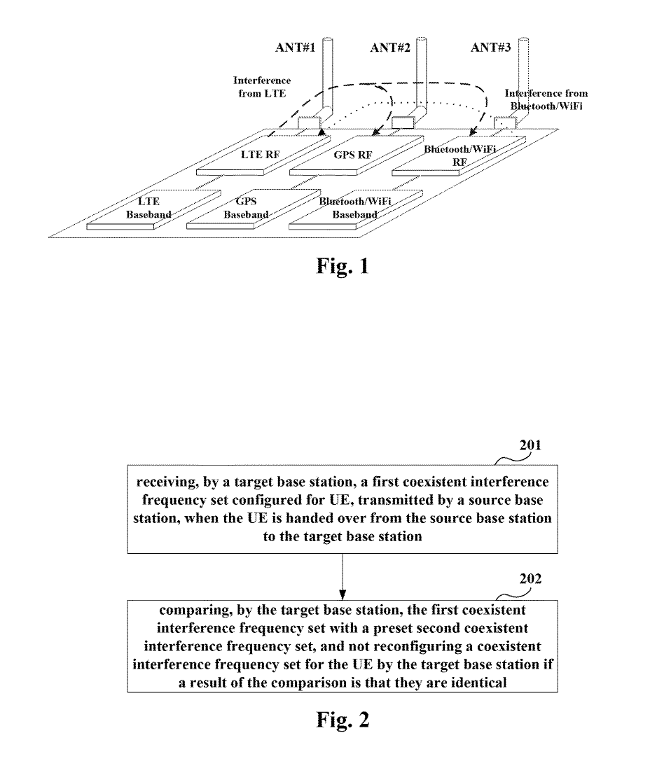

An embodiment of the present disclosure provides configuration method for a coexistent interference frequency set, applicable to a target base station side. FIG. 2 is a flowchart of the configuration method of the embodiment of the present disclosure. As shown in FIG. 2, the configuration method includes:

step 201: receiving, by a target base station, a first coexistent interference frequency set configured for UE transmitted by a source base station, when the UE is handed over from the source base station to the target base station; and

step 202: comparing, by the target base station, the first coexistent interference frequency set with a preset second coexistent interference frequency set, and not reconfiguring a coexistent interference frequency set for the UE if a result of the comparison is that they are identical.

In this embodiment, the first coexistent interference frequency set is configured by the source base station for the UE, and may include one or more pieces of frequency information. For example, the first coexistent interference frequency set may be denoted as follows: A={f₁, f₂, f₃ f₄}. The UE may perform coexistent interference evaluation according to the first coexistent interference frequency set. The relevant art may be referred to for how to configure a coexistent interference frequency set and how to perform coexistent interference evaluation, which shall not be described herein any further.

In this embodiment, different from the relevant art, the source base station transmits the first coexistent interference frequency set to the target base station. The first coexistent interference frequency set may be transmitted via a handover request message. For example, besides existing handover information, the handover request message may further include the first coexistent interference frequency set. However, it is not limited thereto, and other messages may be used according to an actual situation for transmitting the first coexistent interference frequency set.

In particular implementation, transmission may be performed via an X2 interface, and may also be performed via an S1 interface. However, it is not limited thereto, and a particular manner of transmission may be determined according to an actual situation.

The target base station may generate a second coexistent interference frequency set for the UE in advance. The second coexistent interference frequency set may be configured by the target base station according to situations of use of the frequencies of itself and neighboring base stations. For example, the target base station may configure the second coexistent interference frequency set according to frequencies supported by itself and a frequency load status of the neighboring base stations.

The second coexistent interference frequency set may also include one or more pieces of frequency information; wherein, the second coexistent interference frequency set may be identical to or different from the first coexistent interference frequency set; and the second coexistent interference frequency set may contain the first coexistent interference frequency set, or the first coexistent interference frequency set may contain the second coexistent interference frequency set.

In this embodiment, after receiving the first coexistent interference frequency set transmitted by the source base station, the target base station may compare the first coexistent interference frequency set with the second coexistent interference frequency set, and if the first coexistent interference frequency set is identical to the second coexistent interference frequency set (for example, the second coexistent interference frequency set B={f₁, f₂, f₃, f₄}), the target base station does not reconfigure a coexistent interference frequency set for the UE, thereby reducing configuration of coexistent interference frequency sets.

In particular implementation, the target base station may further transmit indication information on use of the first coexistent interference frequency set to the UE. The indication information may be transmitted during the handover process, and may also be transmitted after completion of the handover process, and the UE may proceed with use of the first coexistent interference frequency set.

Therefore, in a case where the UE does not receive the information on reconfiguring a coexistent interference frequency set transmitted by the target base station or receives the indication information on using the first coexistent interference frequency set transmitted by the target base station, the UE may still perform coexistent interference evaluation on the frequencies (such as f₁, f₂, f₃, f₄) of the first coexistent interference frequency set.

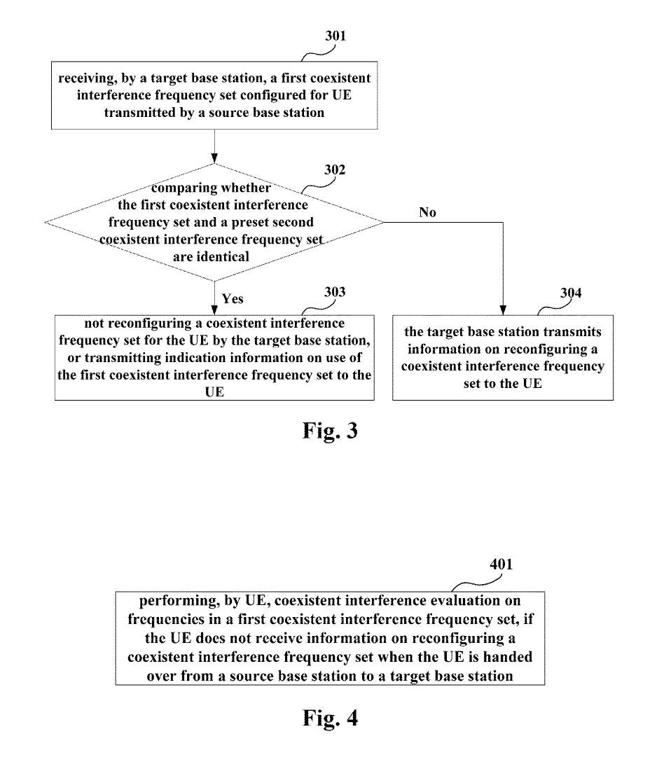

FIG. 3 is another flowchart of the configuration method of the embodiment of the present disclosure. As shown in FIG. 3, the configuration method includes:

step 301: receiving, by a target base station, a first coexistent interference frequency set configured for UE transmitted by a source base station, when the UE is handed over from the source base station to the target base station;

step 302: comparing, by the target base station, the first coexistent interference frequency set with a preset second coexistent interference frequency set, and judging whether a result of the comparison is that they are identical; executing step 303 if the result of the comparison is that they are identical; and executing step 304 if the result of the comparison is that they are different;

step 303: not reconfiguring, by the target base station, a coexistent interference frequency set for the UE, or transmitting indication information on use of the first coexistent interference frequency set to the UE;

in this embodiment, if the first coexistent interference frequency set (for example, set A={f₁, f₂, f₃, f₄}) is identical to the second coexistent interference frequency set (for example, set B={f₁, f₂, f₃, f₄}), the target base station needs not to reconfigure a coexistent interference frequency set for the UE, or transmits an indication message indicating that the UE may use a coexistent interference frequency set identical to that of the source base station. In such a case, the UE may follow a set A of the source base station to perform coexistent interference evaluation;

step 304: reconfiguring, by the target base station, a coexistent interference frequency set for the UE.

In this embodiment, if the first coexistent interference frequency set is different from the second coexistent interference frequency set, the target base station needs to transmit information on reconfiguring a coexistent interference frequency set to the UE. It should noted that the process of reconfiguration may be performed during the handover process; for example, the information on reconfiguring a coexistent interference frequency set may be transmitted to the UE via a handover command; however, it is not limited thereto, and it may also be performed after the process of the handover.

In a mode of implementation, the information on reconfiguring a coexistent interference frequency set may include the second coexistent interference frequency set, so that the UE performs coexistent interference evaluation on frequencies in the second coexistent interference frequency set.

If set A={f₁, f₂, f₃, f₄}) and set B={f₃, f₅, f₆}, the target base station may transmit {f₃, f₅, f₆} to the UE, and the UE performs coexistent interference evaluation on {f₃, f₅, f₆}.

In another mode of implementation, if the first coexistent interference frequency set contains the second coexistent interference frequency set, the information on reconfiguring a coexistent interference frequency set may include a third coexistent interference frequency set, frequencies in the third coexistent interference frequency set being contained in the first coexistent interference frequency set but not contained in the second coexistent interference frequency set. Hence, the UE may perform coexistent interference evaluation on the frequencies contained in the first coexistent interference frequency set but not contained in the third coexistent interference frequency set.

For example, the first coexistent interference frequency set A={f₁, f₂, f₃, f₄, f₅, f₆} and the second coexistent interference frequency set B={f₃, f₄, f₅, f₆}, then the third coexistent interference frequency set C={f₁, f₂}. Therefore, the target base station needs only to transmit {f₁, f₂} to the UE, and the UE may determine to perform coexistent interference evaluation on {f₃, f₅, f₆} according to {f₁, f₂, f₃, f₄, f₅, f₆} and {f₁, f₂}.

In this mode of implementation, for example, in a case where the first coexistent interference frequency set contains the second coexistent interference frequency set and both of the first coexistent interference frequency set and the second coexistent interference frequency set are relatively large, the relatively small third coexistent interference frequency set may only be transmitted, thereby saving communication resources and improving the performance of the system.

In another mode of implementation, if the second coexistent interference frequency set contains the first coexistent interference frequency set, the information on reconfiguring a coexistent interference frequency set may include a fourth coexistent interference frequency set, frequencies in the fourth coexistent interference frequency set being not contained in the first coexistent interference frequency set and being contained in the second coexistent interference frequency set. Therefore, the UE may perform coexistent interference evaluation on the frequencies contained in the first coexistent interference frequency set and frequencies contained in the fourth coexistent interference frequency set.

For example, the first coexistent interference frequency set A={f₃, f₄, f₅, f₆} and the second coexistent interference frequency set B={f₁, f₂, f₃, f₄, f₅, f₆}, then the fourth coexistent interference frequency set C={f₁, f₂}. Therefore, the target base station needs only to transmit {f₁, f₂} to the UE, and the UE may determine to perform coexistent interference evaluation on {f₁, f₂, f₃, f₄, f₅, f₆} according to {f₃, f₄, f₅, f₆} and {f₁, f₂}.

In this mode of implementation, for example, in a case where the second coexistent interference frequency set contains the first coexistent interference frequency set and both of the first coexistent interference frequency set and the second coexistent interference frequency set are relatively large, the relatively small fourth coexistent interference frequency set may only be transmitted, thereby saving communication resources and improving the performance of the system.

In particular implementation, the target base station may further transmit information indicating a coexistent interference frequency set. For example, in transmitting the third coexistent interference frequency set, a bit “0” may be transmitted, the bit identifying that the coexistent interference frequency set is the third coexistent interference frequency set. Therefore, the UE may perform coexistent interference evaluation on the frequencies contained in the first coexistent interference frequency set but not contained in the third coexistent interference frequency set.

In transmitting the fourth coexistent interference frequency set, a bit “1” may be transmitted, the bit identifying that the coexistent interference frequency set is the fourth coexistent interference frequency set. Therefore, the UE may perform coexistent interference evaluation on the frequencies contained in the first coexistent interference frequency set and frequencies contained in the fourth coexistent interference frequency set.

And the information indicating a coexistent interference frequency set may not be transmitted in transmitting the second coexistent interference frequency set, so that the UE may directly perform coexistent interference evaluation on the frequencies contained in the second coexistent interference frequency set.

In particular implementation, different data structures may be defined for different coexistent interference frequency sets. For example, it may be achieved by an information element (IE), the first coexistent interference frequency set using a first type of an information element, the second coexistent interference frequency set using a second type of an information element, the third coexistent interference frequency set using a third type of an information element, and the fourth coexistent interference frequency set using a fourth type of an information element.

In receiving the third type of an information element, the UE may determine that the information element correspond to the third coexistent interference frequency set, hence, it may perform coexistent interference evaluation on the frequencies contained in the first coexistent interference frequency set but not contained in the third coexistent interference frequency set.

In receiving the fourth type of an information element, the UE may determine that the information element correspond to the fourth coexistent interference frequency set, hence, it may perform coexistent interference evaluation on the frequencies contained in the first coexistent interference frequency set and the frequencies contained in the fourth coexistent interference frequency set.

In receiving the second type of an information element, the UE may determine that the information element correspond to the second coexistent interference frequency set, hence, it may directly perform coexistent interference evaluation on the frequencies contained in the second coexistent interference frequency set.

It should be noted that the above modes of implementation are just illustrative explanation to how to reconfigure a coexistent interference frequency set. However, it is not limited thereto, and a particular mode of implementation may be determined according to an actual situation.

It can be seen from the above embodiment that: receiving by a target base station a first coexistent interference frequency set configured for UE transmitted by a source base station when the UE is handed over from the source base station to the target base station, and not reconfiguring a coexistent interference frequency set for the UE by the target base station if the first coexistent interference frequency set and the second coexistent interference frequency set are identical, configuration of coexistent interference frequency by the base station may be reduced, waste of system resources may lowered, and performance of the system may be improved.

### Embodiment 2

An embodiment of the present disclosure provides a configuration method for a coexistent interference frequency set, which is described on the basis of Embodiment 1 from a UE side, with the contents identical to those in Embodiment 1 being not going to be described herein any further.

FIG. 4 is a flowchart of the configuration method of the embodiment of the present disclosure. As shown in FIG. 4, the configuration method includes:

step 401: performing, by UE, coexistent interference evaluation on frequencies in a first coexistent interference frequency set when the UE does not receive information on reconfiguring a coexistent interference frequency set;

wherein the first coexistent interference frequency set is configured by a source base station; when the UE is handed over from the source base station to a target base station, the first coexistent interference frequency set is transmitted by the source base station to the target base station; and the target base station does not reconfigure a coexistent interference frequency set for the UE if the first coexistent interference frequency set is identical to a preset second coexistent interference frequency set.

In this embodiment, if the UE does not receive the information on reconfiguring a coexistent interference frequency set transmitted by the target base station, it may proceed with using the first coexistent interference frequency set configured by the source base station, thereby reducing configuration of coexistent interference frequency sets.

In particular implementation, the method may further include: receiving, by the UE, indication information for using the first coexistent interference frequency set transmitted by the target base station; and performing coexistent interference evaluation on frequencies in the first coexistent interference frequency set by the UE according to the indication information.

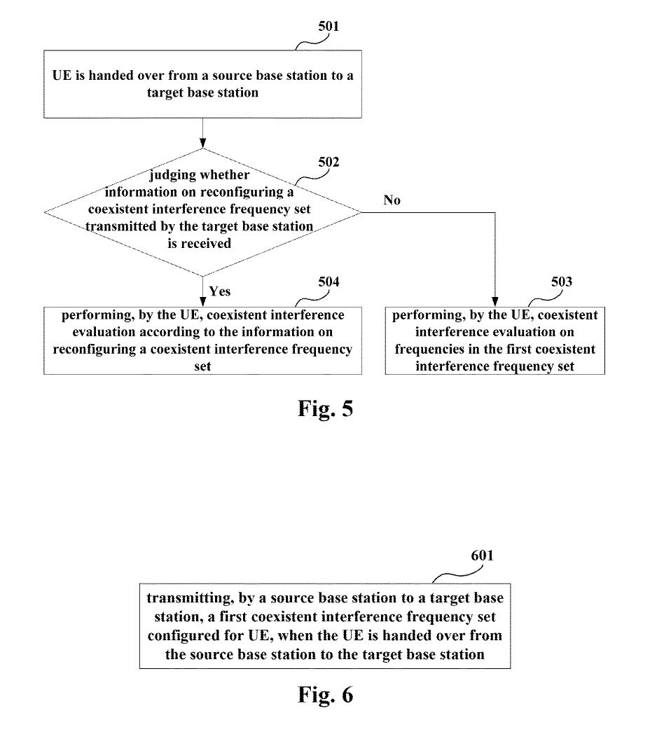

FIG. 5 is another flowchart of the configuration method of the embodiment of the present disclosure. As shown in FIG. 5, the configuration method includes:

step 501: UE is handed over from a source base station to a target base station;

step 502: judging, by the UE, whether information on reconfiguring a coexistent interference frequency set transmitted by the target base station is received; executing step 503 if the information on reconfiguring a coexistent interference frequency set is not received; and executing step 504 if the information on reconfiguring a coexistent interference frequency set is received;

in this embodiment, the UE may further receive indication information on using a first coexistent interference frequency set transmitted by the target base station, and step 503 is executed after the indication information is received;

step 503: performing, by the UE, coexistent interference evaluation on frequencies in the first coexistent interference frequency set; and

step 504: performing, by the UE, coexistent interference evaluation according to the information on reconfiguring a coexistent interference frequency set.

In a mode of implementation, the information on reconfiguring a coexistent interference frequency set may include a second coexistent interference frequency set, and the UE performs coexistent interference evaluation on the frequencies in the second coexistent interference frequency set.

In another mode of implementation, the information on reconfiguring a coexistent interference frequency set may include a third coexistent interference frequency set; wherein, the first coexistent interference frequency set contains the second coexistent interference frequency set, and frequencies in the third coexistent interference frequency set are contained in the first coexistent interference frequency set but are not contained in the second coexistent interference frequency set. And the UE performs coexistent interference evaluation on the frequencies contained in the first coexistent interference frequency set but not contained in the third coexistent interference frequency set.

In a further mode of implementation, the information on reconfiguring a coexistent interference frequency set may include a fourth coexistent interference frequency set; wherein, the second coexistent interference frequency set contains the first coexistent interference frequency set, and frequencies in the fourth coexistent interference frequency set are not contained in the first coexistent interference frequency set but are contained in the second coexistent interference frequency set. And the UE performs coexistent interference evaluation on the frequencies contained in the first coexistent interference frequency and the frequencies contained in the fourth coexistent interference frequency set.

It can be seen from the above embodiment that: receiving by a target base station a first coexistent interference frequency set configured for UE transmitted by a source base station when the UE is handed over from the source base station to the target base station, and not reconfiguring a coexistent interference frequency set for the UE by the target base station if the first coexistent interference frequency set and the second coexistent interference frequency set are identical, configuration of coexistent interference frequency by the base station may be reduced, waste of system resources may lowered, and performance of the system may be improved.

### Embodiment 3

An embodiment of the present disclosure provides a configuration method for a coexistent interference frequency set, which is fully described on the basis of embodiments 1 and 2 from a source base station side, a target base station side and a UE side, with the contents identical to those in embodiments 1 and 2 being not going to be described herein any further.

FIG. 6 is a flowchart of the configuration method of the embodiment of the present disclosure. As shown in FIG. 6, the configuration method includes:

step 601: transmitting, by a source base station to a target base station, a first coexistent interference frequency set configured for UE, when the UE is handed over from the source base station to the target base station;

wherein, the source base station may transmit the first coexistent interference frequency set via a handover request message. In particular implementation, transmission may be performed via an X2 interface, and may also be performed via an S1 interface. However, it is not limited thereto, and a particular message and a manner of transmission may be determined according to an actual situation.

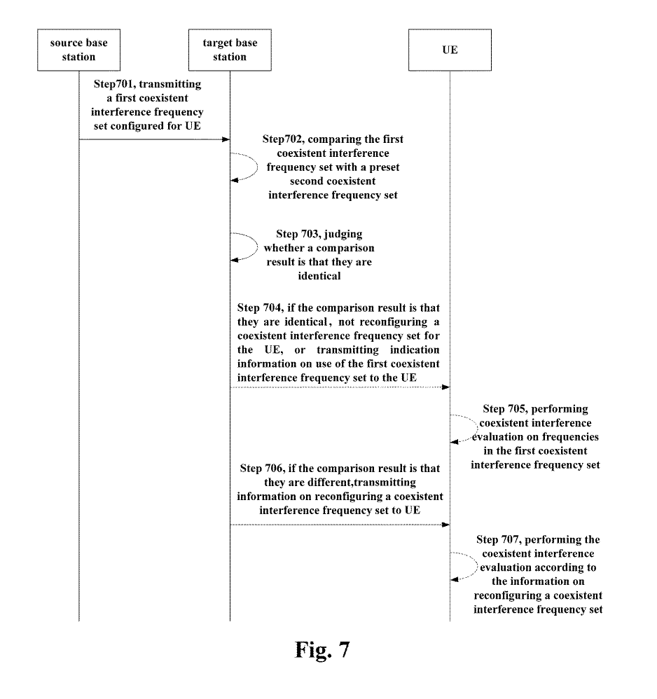

FIG. 7 is another flowchart of the configuration method of the embodiment of the present disclosure. As shown in FIG. 7, the configuration method includes:

step 701: transmitting, by a source base station to a target base station, a first coexistent interference frequency set configured for UE, when the UE is handed over from the source base station to the target base station;

step 702: comparing, by the target base station, the first coexistent interference frequency set with a preset second coexistent interference frequency set, after receiving the first coexistent interference frequency set configured for UE transmitted by the source base station;

step 703: judging, by the target base station, whether a comparison result is that they are identical; executing step 704 if the comparison result is that they are identical; and executing step 706 if the comparison result is that they are different;

step 704: not reconfiguring, by the target base station, the UE with a coexistent interference frequency set, or transmitting indication information on use of the first coexistent interference frequency set to the UE;

step 705: performing, by the UE, coexistent interference evaluation on frequencies in the first coexistent interference frequency set;

in this embodiment, if the first coexistent interference frequency set (set A) is identical to the second coexistent interference frequency set (set B), the target base station needs not to reconfigure the coexistent interference frequency set for the UE, or may transmit an indication message indicating that the UE may use a coexistent interference frequency set identical to that of the source base station. In such a case, the UE may follow the set A of the source base station for performing the coexistent interference evaluation;

step 706: transmitting, by the target base station to the UE, information on reconfiguring a coexistent interference frequency set; and

step 707: performing, by the UE, the coexistent interference evaluation according to the information on reconfiguring a coexistent interference frequency set.

In this embodiment, if the set A is different from the set B, the target base station will reconfigure a coexistent interference frequency set for the UE. In particular implementation, the target base station may reconfigure the set B for the UE, and the UE performs coexistent interference evaluation on frequencies in the set B.

Or, if the set A contains the set B, the target base station may notify the UE that which frequencies in the original set (i.e. the set A) are not in the set B (such as a redundant set C), and the UE performs coexistent interference evaluation on frequencies belonging to the set A but not belonging to the redundant set C.

Or, if the set B contains the set A, the target base station may notify the UE that which frequencies (such as a new frequency set D) are added in the target base station besides the frequencies in the original set (i.e. the set A), and the UE performs coexistent interference evaluation on frequencies belonging to the set A and the new frequency set D.

It can be seen from the above embodiment that: receiving by a target base station a first coexistent interference frequency set configured for UE transmitted by a source base station when the UE is handed over from the source base station to the target base station, and not reconfiguring a coexistent interference frequency set for the UE by the target base station if the first coexistent interference frequency set and the second coexistent interference frequency set are identical, configuration of coexistent interference frequency by the base station may be reduced, waste of system resources may lowered, and performance of the system may be improved.

### Embodiment 4

An embodiment of the present disclosure provides a base station, which is a target base station when UE is handed over. This embodiment corresponds to Embodiment 1, and the same contents shall not be described herein any further.

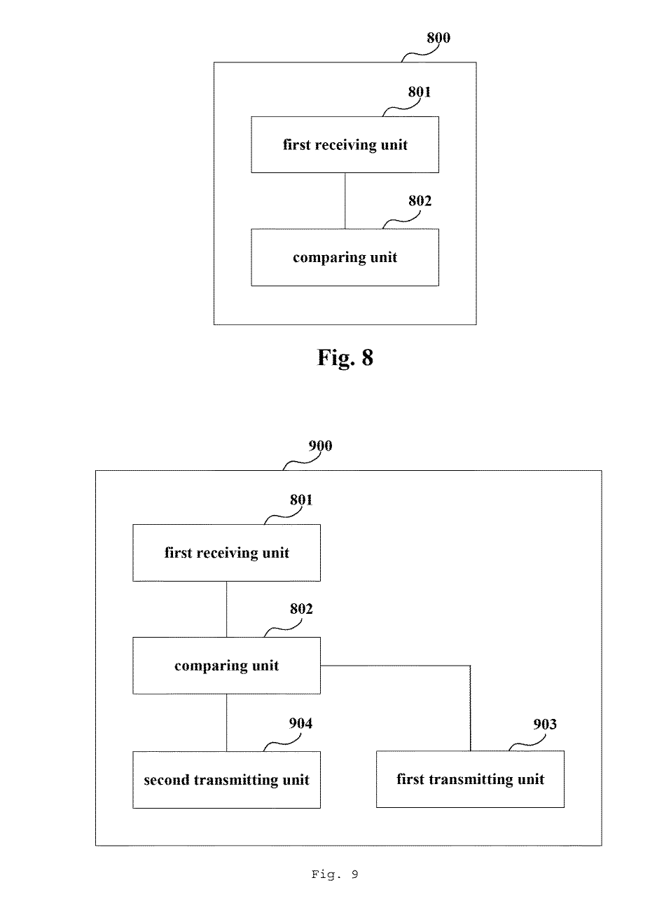

FIG. 8 is a schematic diagram of the structure of the base station of the embodiment of the present disclosure. As shown in FIG. 8, the base station 800 includes: a first receiving unit 801 and a comparing unit 802. The relevant art may be referred to for other parts of the base station 800, which shall not be described herein any further;

wherein, the first receiving unit 801 is configured to receive a first coexistent interference frequency set configured for UE transmitted by a source base station, when the UE is handed over from the source base station to a target base station; and the comparing unit 802 is configured to compare the first coexistent interference frequency set with a preset second coexistent interference frequency set; wherein if a result of the comparison is that they are identical, the target base station does not reconfigure a coexistent interference frequency set for the UE.

FIG. 9 is another schematic diagram of the structure of the base station of the embodiment of the present disclosure. As shown in FIG. 9, the base station 900 includes: a first receiving unit 801 and a comparing unit 802, as described above.

As shown in FIG. 9, the base station 900 may further include: a first transmitting unit 903 configured to transmit indication information for using the first coexistent interference frequency set to the UE when the first coexistent interference frequency set and the second coexistent interference frequency set are identical.

As shown in FIG. 9, the base station 900 may further include: a second transmitting unit 904 configured to transmit information on reconfiguring a coexistent interference frequency set to the UE, if a result of comparison of the comparing unit 802 is that the first coexistent interference frequency set is different from the second coexistent interference frequency set.

In this embodiment, the second coexistent interference frequency set is configured by the target base station according to situations of use of the frequencies of itself and neighboring base stations.

It can be seen from the above embodiment that: receiving by a target base station a first coexistent interference frequency set configured for UE transmitted by a source base station when the UE is handed over from the source base station to the target base station, and not reconfiguring a coexistent interference frequency set for the UE by the target base station if the first coexistent interference frequency set and the second coexistent interference frequency set are identical, configuration of coexistent interference frequency by the base station may be reduced, waste of system resources may lowered, and performance of the system may be improved.

### Embodiment 5

An embodiment of the present disclosure provides UE, which is handed over from a source base station to a target base station. This embodiment corresponds to Embodiment 2, and the same contents shall not be described herein any further.

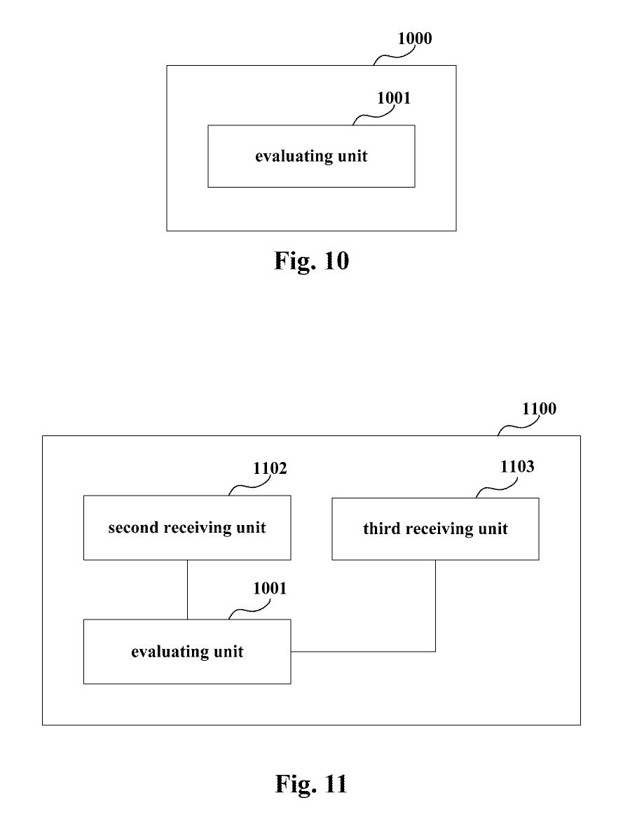

FIG. 10 is a schematic diagram of the structure of the UE of the embodiment of the present disclosure. As shown in FIG. 10, the UE 1000 includes: an evaluating unit 1001. The relevant art may be referred to for other parts of the UE 1000, which shall not be described herein any further;

wherein, the evaluating unit 1001 is configured to perform coexistent interference evaluation on frequencies in a first coexistent interference frequency set when no information on reconfiguring a coexistent interference frequency set is received;

wherein the first coexistent interference frequency set is configured by a source base station; when the UE is handed over from the source base station to a target base station, the first coexistent interference frequency set is transmitted by the source base station to the target base station; and the target base station does not reconfigure a coexistent interference frequency set for the UE if the first coexistent interference frequency set is identical to a preset second coexistent interference frequency set.

FIG. 11 is another schematic diagram of the structure of the UE of the embodiment of the present disclosure. As shown in FIG. 11, the UE 1100 includes an evaluating unit 1001, as described above.

As shown in FIG. 11, the UE 1100 may further include: a second receiving unit 1102 configured to receive indication information for using the first coexistent interference frequency set transmitted by the target base station. And the evaluating unit 1001 is further configured to perform coexistent interference evaluation on frequencies in the first coexistent interference frequency set after it receives the indication information.

As shown in FIG. 11, the UE 1100 may further include: a third receiving unit 1103 configured to receive information on reconfiguring a coexistent interference frequency set for the UE transmitted by the target base station. And the evaluating unit 1001 is further configured to evaluate the coexistent interference according to the information on reconfiguring a coexistent interference frequency set.

In an embodiment, the information on reconfiguring a coexistent interference frequency set includes the second coexistent interference frequency set; and the evaluating unit 1001 performs coexistent interference evaluation on frequencies in the second coexistent interference frequency set.

In another embodiment, the information on reconfiguring a coexistent interference frequency set includes a third coexistent interference frequency set; the first coexistent interference frequency set contains the second coexistent interference frequency set, and frequencies in the third coexistent interference frequency set are contained in the first coexistent interference frequency set but not contained in the second coexistent interference frequency set; and the evaluating unit 1001 performs coexistent interference evaluation on frequencies contained in the first coexistent interference frequency set but not contained in the third coexistent interference frequency set.

In still another embodiment, the information on reconfiguring a coexistent interference frequency set includes a fourth coexistent interference frequency set; the second coexistent interference frequency set contains the first coexistent interference frequency set, and frequencies in the fourth coexistent interference frequency set are not contained in the first coexistent interference frequency set but contained in the second coexistent interference frequency set; and the evaluating unit 1001 performs coexistent interference evaluation on the frequencies contained in the first coexistent interference frequency set and the frequencies contained in the fourth coexistent interference frequency set.

It can be seen from the above embodiment that: receiving by a target base station a first coexistent interference frequency set configured for UE transmitted by a source base station when the UE is handed over from the source base station to the target base station, and not reconfiguring a coexistent interference frequency set for the UE by the target base station if the first coexistent interference frequency set and the second coexistent interference frequency set are identical, configuration of coexistent interference frequency by the base station may be reduced, waste of system resources may lowered, and performance of the system may be improved.

### Embodiment 6

An embodiment of the present disclosure provides a base station, which is a source base station when UE is handed over. This embodiment corresponds to Embodiment 3, and the same contents shall not be described herein any further.

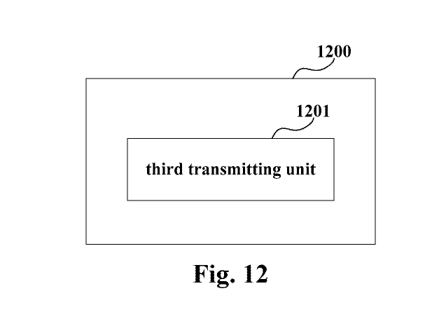

FIG. 12 is a schematic diagram of the structure of the base station of the embodiment of the present disclosure. As shown in FIG. 12, the base station 1200 includes: a third transmitting unit 1201. The relevant art may be referred to for other parts of the base station 1200, which shall not be described herein any further;

wherein, the third transmitting unit 1201 is configured to transmit a first coexistent interference frequency set configured for UE to a target base station, when the UE is handed over from a source base station to the target base station;

wherein, the third transmitting unit 1201 may transmit the first coexistent interference frequency set via a handover request message.

It can be seen from the above embodiment that: receiving by a target base station a first coexistent interference frequency set configured for UE transmitted by a source base station when the UE is handed over from the source base station to the target base station, and not reconfiguring a coexistent interference frequency set for the UE by the target base station if the first coexistent interference frequency set and the second coexistent interference frequency set are identical, configuration of coexistent interference frequency by the base station may be reduced, waste of system resources may lowered, and performance of the system may be improved.

An embodiment of the present disclosure provides a computer-readable program, wherein when the program is executed in a base station, the program enables a computer to carry out the configuration method for a coexistent interference frequency set as described above in the base station.

An embodiment of the present disclosure provides a storage medium in which a computer-readable program is stored, wherein the computer-readable program enables a computer to carry out the configuration method for a coexistent interference frequency set as described above in a base station.

An embodiment of the present disclosure provides a computer-readable program, wherein when the program is executed in UE, the program enables a computer to carry out the configuration method for a coexistent interference frequency set as described above in the UE.

An embodiment of the present disclosure provides a storage medium in which a computer-readable program is stored, wherein the computer-readable program enables a computer to carry out the configuration method for a coexistent interference frequency set as described above in UE.

The above apparatus and method of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

What is claimed is:

1. A base station, comprising:
a transmitter, configured to transmit a first coexistent interference frequency set configured for UE to a target base station, when the UE is handed over from a source base station to the target base station;
wherein coexistence interference on each frequency in the first coexistence interference frequency set is to be evaluated by the UE when the UE is in a cell of the source base station, and the evaluation results indicate that whether there exists coexistent interference on each frequency in the first coexistent interference frequency set.

2. The base station according to claim 1, wherein the transmitter further configured to transmit the first coexistent interference frequency set via a handover request message.

3. UE, comprising:
a processor circuit, configured to perform coexistent interference evaluation on each frequency in a first coexistent interference frequency set when the UE is in a cell of a source base station, and the evaluation results indicate that whether there exists coexistent interference on each frequency in the first coexistent interference frequency set; and perform coexistent interference evaluation on each frequency in a second configured coexistence interference frequency set when the UE is in a cell of a target base station, and the evaluation results indicate that whether there exists coexistent interference on each frequency in the second coexistent interference frequency set.

4. The UE according to claim 3, wherein the first coexistent interference frequency set is configured by the source base station; when the UE is handed over from the source base station to the target base station, the first coexistent interference frequency set is transmitted by the source base station to the target base station; and the target base station does not transmit information on reconfiguring a coexistent interference frequency set for the UE if the first coexistent interference frequency set is identical to a preset coexistent interference frequency set.

5. The UE according to claim 3, wherein the UE further comprises:
a receiver, configured to receive indication information for using the first coexistent interference frequency set, transmitted by the target base station;
and the processor circuit further configured to perform coexistent interference evaluation on each frequency in the first coexistent interference frequency set after the UE receives the indication information.

6. The UE according to claim 3, wherein
the receiver further configured to receive information on reconfiguring a coexistent interference frequency set for the UE, transmitted by the target base station;
and the rocessor circuit further configured to evaluate the coexistent interference according to the information on reconfiguring a coexistent interference frequency set.

7. The UE according to claim 3, wherein the information on reconfiguring a coexistent interference frequency set comprises the preset coexistent interference frequency set;
and the processor circuit further configured to perform coexistent interference evaluation on each frequency in the preset coexistent interference frequency set.

8. The UE according to claim 3, wherein the information on reconfiguring a coexistent interference frequency set comprises a third coexistent interference frequency set; the first coexistent interference frequency set contains the preset coexistent interference frequency set, and each frequency in the third coexistent interference frequency set are contained in the first coexistent interference frequency set but not contained in the preset coexistent interference frequency set;
and the processor circuit further configured to perform coexistent interference evaluation on each frequency contained in the first coexistent interference frequency set but not contained in the third coexistent interference frequency set.

9. The UE according to claim 3, wherein the information on reconfiguring a coexistent interference frequency set comprises a fourth coexistent interference frequency set; the preset coexistent interference frequency set contains the first coexistent interference frequency set, and each frequency in the fourth coexistent interference frequency set are not contained in the first coexistent interference frequency set but contained in the preset coexistent interference frequency set;
and the processor circuit further configured to perform coexistent interference evaluation on the each frequency contained in the first coexistent interference frequency set and the each frequency contained in the fourth coexistent interference frequency set.
